(19) United States
(12) Patent Application Publication
(10) Pub. No.: US 2012/0289076 A1
(43) Pub. Date: Nov. 15, 2012

(54) SPRING-TO BOARD I/O-CONNECTOR ASSEMBLY, MEMBERS THEREOF AND BOARD PROVIDED THEREWITH

(75) Inventors: Martin Wolff, Lund (SE); Daniel Skagmo, Malmo (SE); Alin Bontidean, Staffanstorp (SE); Jonny Strandh, Hoor (SE)

(73) Assignee: SONY MOBILE COMMUNICATIONS AB, Lund (SE)

(21) Appl. No.: 13/501,133

(22) PCT Filed: May 13, 2011
(86) PCT No.: PCT/EP2011/057758

§ 371 Date: Apr. 10, 2012

(51) Int. Cl. H01R 4/48

(52) U.S. Cl. 439/345

(57) ABSTRACT

A board connector assembly, comprises a shield and securing member as well as a connector member. The shield and securing member is configured for mounting on a board close to contacts on the board and is provided with a coupling for securing the connector member thereto. The connector member is provided with coupling for cooperation with the coupling on the shield and securing member for securing the connector member to the shield and securing member, thereby preventing the connector member from disturbing surrounding circuitry, and is further provided with contacts which, when the connector member is secured to the shield and securing member, is connected to the contacts on the board. The present invention also relates to shield and securing member and a connector member, respectively, for use in the board connector assembly, as well as to a printed wiring board comprising one or more board connector assemblies.

### TECHNICAL FIELD

The present invention relates generally to a board connector assembly and more particularly to a spring-to-board connector assembly. The present invention further relates to a shield and securing member and a connector member forming part of a board connector assembly as well as to a printed wiring board comprising one or more board connector assemblies.

### BACKGROUND OF THE INVENTION

Connectors, particularly input and output connectors (I/O-connectors), transmit data in increasingly high data rates. The frequencies may cause EMI (electromagnetic interference)/EMC (electromagnetic compatibility)-disturbances in surrounding circuitry. It is known that such disturbances are more severe when using a spring-to-board connector because its spring terminals may work as antennas. Furthermore, soldered I/O-connectors are object to high bending forces which may cause damage to said connectors. Spring-to-board connectors however, offer easy repair and strong reliability at high mechanical loads.

### SUMMARY OF THE INVENTION

The object of the present invention is therefore to provide an improved board connector assembly which combines e.g. solder and spring-to-board connections to eliminate the above-mentioned disadvantages.

The above object is achieved according to the present invention by providing a board connector assembly comprising a shield and securing member as well as a connector member, wherein the shield and securing member is configured for mounting on a board close to one or more contact means on said board, said shield and securing member further being provided with one or more coupling means for securing the connector member thereto, and wherein the connector member is provided with one or more coupling means for cooperation with the coupling means on the shield and securing member for securing said connector member to said shield and securing member and thereby shielding said connector member from surrounding circuitry, said connector member further being provided with one or more contact means which, when said connector member is secured to the shield and securing member, are connected to the contact means on the board.

Another object of the present invention is to provide an improved shield and securing member which is configured for use in a board connector assembly as defined above, with the same capacity of securing and shielding a connector member.

A further object of the present invention is to provide an improved connector member which is configured for use in the above-mentioned board connector assembly, with ability to form a firm and close fit with a shield and securing member and provide a reliable connection to contact means on particularly a printed wiring board.

A final object of the present invention is to provide a printed wiring board which comprises one or more of the above-mentioned board connector assemblies.

### BRIEF DESCRIPTION OF THE DRAWINGS

The present invention will be further described below by way of example only and with reference to the accompanying drawing, in which

FIG. 1 is a schematic perspective view of a shield and securing member and of the housing of a connector member of a board connector assembly according to the invention, said shield and securing member being mounted on a printed wiring board (PWB), and

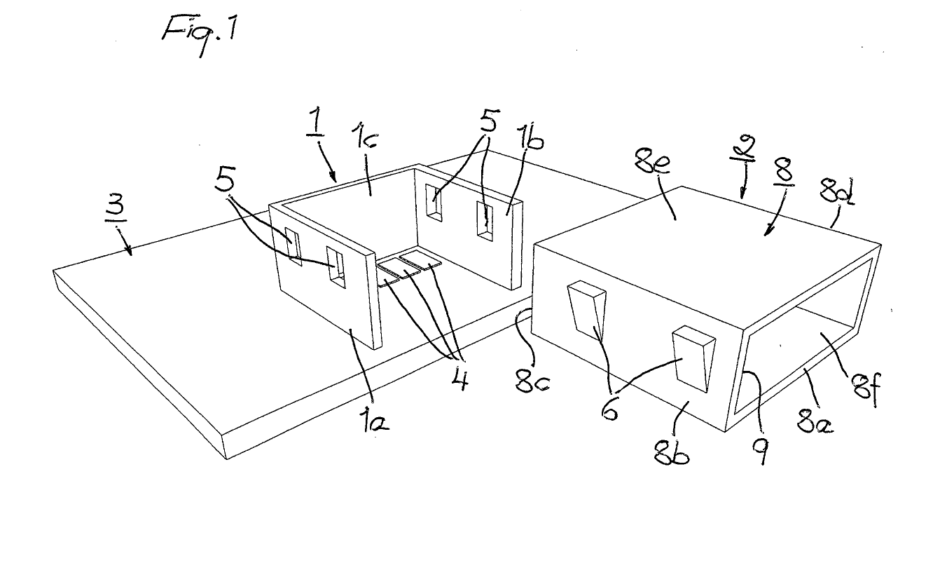

FIG. 2 is another schematic perspective view of the shield and securing member and of the housing of the connector member of the board connector assembly of the invention.

### DETAILED DESCRIPTION OF PREFERRED EMBODIMENTS

Thus, as already stated, the present invention relates to a board connector assembly, particularly a spring-to-board connector assembly in which the connector member is an I/O-connector. In the illustrated embodiment, the board connector assembly comprises a shield and securing member 1 and a connector member 2.

The shield and securing member 1 is configured in any suitable manner for mounting on a board 3 close to one or more contact means 4 on said board 3. In the illustrated embodiment, the board is a printed wiring board 3 and the contact means comprise contact pads 4. However, the type of board and contact means may vary. The shield and securing member 1 is also provided with one or more coupling means 5 for securing the connector member 2 to said shield and securing member 1, which will be described in more detail below.

In order to facilitate mounting of the shield and securing member 1 on the board 3, said shield and securing member 1 may be made of a suitable metal or metal alloy for soldering onto the board 3. The board 3 may be provided with one or more shield and securing members 1 for connection thereto of one or more connector members 2, each shield and securing member 1 thereby being mounted close to one or more separate contact means 4 on said board 3.

The connector member 2 is also provided with one or more coupling means 6 for cooperation with the coupling means 5 on the shield and securing member 1. The purpose therewith is, as already stated, to secure the connector member 2 to the shield and securing member 1 and to do this such that said connector member 2 is shielded from surrounding circuitry on e.g. the board 3 and thereby prevented from causing disturbances in said surrounding circuitry. The coupling means 5, 6 on the shield and securing member 1 and the connector member 2 respectively, may be configured in any suitable manner and in any number for the intended purpose. In the illustrated embodiment however, the coupling means on the shield and securing member 1 comprise snap-in means 5 which cooperate with coupling means in the form of mating snap-in means 6 on the connector member 2. In the illustrated embodiment, the snap-in means on the shield and securing member 1 consist of snap-in holes 5 and the snap-in means on the connector member 2 consist of snap-in fingers 6. On the other hand, the snap-in means on the shield and securing member 1 may consist of snap-in fingers and the snap-in means on the connector member 2 may consist of snap-in holes. Thus, when the connector member 2 is snapped onto the shield and securing member 1, the snap-in fingers 6 on the connector member 2 snap into the snap-in holes 5 in the shield and securing member 1 and the connector member 2 is safely secured to the shield and securing member 1, the shield and securing member 1 thereby functioning as a socket for the connector member 2. Accordingly, the coupling means 5, 6 on said members 1, 2 are in the illustrated embodiment made in or made of portions of said members 1, 2, but may alternatively comprise separate means for the intended purpose which in any suitable manner are provided on said members 1, 2.

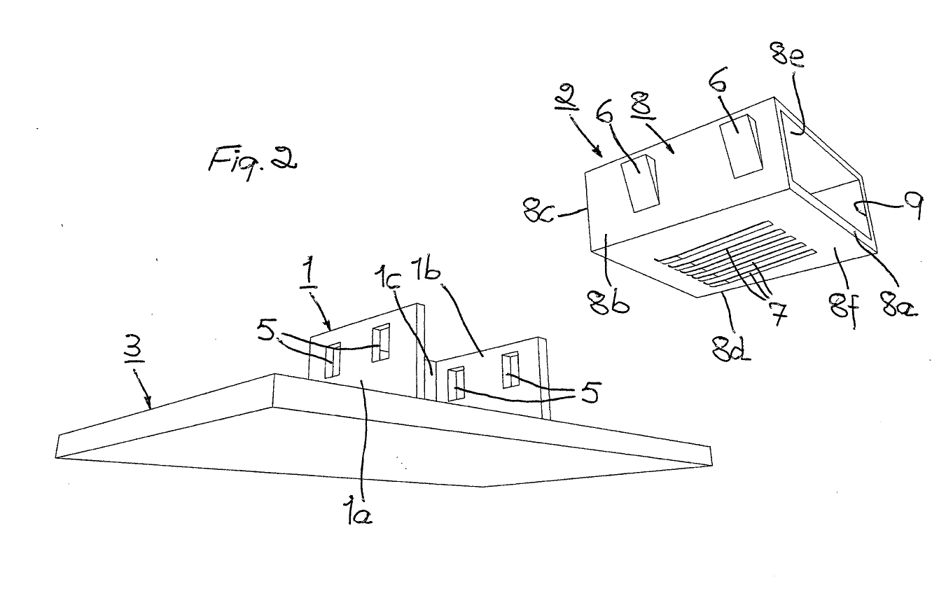

The connector member 2 is further provided with one or more contact means 7 (schematically illustrated in FIG. 2) which, when said connector member 2 is secured to the shield and securing member 1, is connected to said one or more contact means 4 on the board 3, i.e. the snap-in means or any other coupling means 5, 6 on the shield and securing member 1 and the connector member 2 respectively, also operate to establish an electric connection between said contact means 4, 7. The contact means 7 on the connector member 2 may be of varying type. The contact means may e.g. comprise spring means 7, as illustrated in FIG. 2, for easy connection to the contact pads 4 on the board 3.

The connector member 2 may be of any suitable type for USB, HDMI or any other connector design, particularly any other I/O-connector design.

In order to provide safe and effective shielding of the connector member 2 when said connector member 2 is secured to the shield and securing member 1 and the contact means 7 thereon are connected to the contact means 4 on the board 3, the shield and securing member 1 is configured such that it after mounting thereof on the board 3 encloses said one or more contact means 4 on said board 3, thereby defining, as stated, a socket with a receiving section for the connector member 2 about said contact means 4. In the illustrated embodiment, the shield and securing member 1 is thereby substantially [symbol] -shaped, surrounding said one or more contact means 4 on the board 3 on three sides and with the receiving section for the connector member 2 between the shanks 1a and 1b and the web 1c of said substantially [symbol] -shaped shield and securing member 1. In the illustrated embodiment, the shanks 1a, 1b of the substantially [symbol] -shaped shield and securing member 1 extend from the web 1c substantially perpendicular thereto, i.e. the shanks 1a, 1b run substantially in parallel to each other but may, if desired, e.g. converge towards each other or diverge from each other in a direction away from the web 1c of said substantially [symbol] -shaped shield and securing member 1. The receiving section for the connector member 2 defined by the shield and securing member 1 has thereby, in the illustrated embodiment, the same width along its entire length from the web 1c of the substantially [symbol] -shaped shield and securing member 1 to the free ends of the shanks 1a, 1b thereof. The relative length of the shanks 1a, 1b and of the web 1c respectively, of the shield and securing member 1 may vary, depending on e.g. the number and arrangement of the contact means to be surrounded by said shield and securing member 1. In the illustrated embodiment, the shanks 1a, 1b and the web 1c have substantially the same length.

The connector member 2 comprises a housing 8 which is configured to fit within the substantially [symbol] -shaped shield and securing member 1, i.e. between the shanks 1a, 1b and web 1c of the substantially [symbol] -shaped shield and securing member 1. Thus, in the illustrated embodiment, the housing 8 has a block-like shape with four side surfaces 8a-d, one top surface 8e and one bottom surface 8f. Since, as stated, the shanks 1a of the substantially [symbol] -shaped shield and securing member 1 in the illustrated embodiment run substantially in parallel relative to each other in a direction away from the web 1b of said substantially [symbol] -shaped shield and securing member 1, the housing 8 of the connector member 2 has, in the illustrated embodiment, a corresponding shape and size in order to fit within the shield and securing member 1, in the receiving section defined thereby, i.e. two opposing side surfaces 8b and 8d of the housing 8 also run substantially in parallel to each other and substantially perpendicular to the side surface 8c which after location of the connector member 2 in the receiving section defined by the shield and securing member 1 faces the web 1c of said shield and securing member 1. This corresponding shape and size of the shield and securing member 1 and of the connector member 2 provides for a tight fit between said members 1, 2 and the coupling means 5, 6 prevent withdrawal of the connector member 2 from the shield and securing member 1 in a direction towards the free space between the shanks 1a of said shield and securing member 1 as well as in upwards direction, away from the board 3. Consequently, in the illustrated embodiment, with the coupling means 5, 6 defined as illustrated in the drawings and described above, the connector member 2 may be located in the receiving section defined by the shield and securing member 1 and secured to said shield and securing member 1 primarily from above, i.e. in a direction towards the board 3, but also in a direction from the free space between the shanks 1a, 1b and towards the web 1c of the shield and securing member 1.

The housing 8 of the connector member 2 is provided with an opening 9 facing the free space between the shanks 1a of the substantially [symbol] -shaped shield and securing member 1. The opening 9 provides access to the hollow interior of the housing 8. The contact means 7 on the connector member 2 are connected to one or more terminals (not illustrated in the drawings) which are inserted into the housing 8 of said connector member 2 through the opening 9 in said housing 8. The contact means 7 are located on the bottom surface 8f of the housing 8 of the connector member 2 (see FIG. 2).

It is also the two side surfaces 8b, 8d of the housing 8 of the connector member 2 and the two shanks 1a, 1b of the shield and securing member 1, respectively, which in the illustrated embodiment are provided with coupling means in the form of mating snap-in holes 5 and snap-in fingers 6, respectively, two on each side surface 8b, 8d and each shank 1a, 1b respectively. If desired, there may be one or more than two coupling means 5, 6 on each of said side surfaces 8b, 8d and said shanks 1a, 1b, respectively, and there may be more coupling means 5, 6 on the web 1c of the shield and securing member 1 and on the side surface 8c opposite to the side surface 8a with the opening 9, respectively. In the illustrated embodiment, the mating coupling means 5, 6 are designed such that they, as indicated above, are brought to cooperate when the connector member 2 primarily from above is moved into the receiving section defined by the shield and securing member 1. Thus, when the shield and securing member 1 and the connector member 2 are mounted on the board 3 as described, the coupling means 5, 6 secure said members 1, 2 to each other in a direction perpendicular to the plane of said board 3, i.e. up from said board, but also in a direction along said plane of said board 3.

After mounting of the shield and securing member 1 on the board 3 and after securing the connector member 2 to said shield and securing member 1, a mechanical support (not shown) forming part of the board connector assembly 1, 2 may be applied to secure the connector member 2 and improve its load-carrying capacity. This mechanical support may be configured in any suitable manner.

The shield and securing member 1, providing a safe and reliable attachment for the connector member 2 to the board 3 as well as an efficient shield for the connector member 2, such that no disturbances are caused thereby in surrounding circuitry, and having the features described above, is also a part of the present invention.

The connector member 2, having the features described above for safe attachment to the shield and securing member 1 and a positive and safe connection to the contact means 4 on the board 3, forms a part of the present invention as well.

Finally, a printed wiring board 3 comprising one or more of the above-mentioned board connector assemblies 1, 2 which each in turn comprises a shield and securing member 1 as defined above and a connector member 2 as defined above, forms a part of the present invention.

It will be evident to a skilled person that the board connector assembly, the members thereof and the printed wiring board with one or more board connector assemblies according to the present invention can be modified and altered within the scope of the subsequent claims without departing from the idea and purpose of the invention. Thus, the shape, size and design of the shield and securing member 1 as well as of the connector member 2 and the coupling means 5, 6 and other parts and components thereof may vary, based on e.g. their intended use and the environment in which they shall operate, i.e. audio communication, power communication, HDMI, USB etc.

1. Board connector assembly, comprising
a shield and securing member as well as a connector member,
wherein the shield and securing member is configured for mounting on a board close to one or more contact means on said board, said shield and securing member further being provided with one or more coupling means for securing the connector member thereto, and
wherein the connector member is provided with one or more coupling means for cooperation with the coupling means on the shield and securing member for securing said connector member to said shield and securing member and thereby shielding said connector member from surrounding circuitry, said connector member further being provided with one or more contact means which, when said connector member is secured to the shield and securing member, are connected to the contact means on the board.

2. Board connector assembly according to claim 1, wherein the shield and securing member is configured such that, after mounting thereof on the board, it encloses said one or more contact means on said board, defining a receiving section for the connector member about said contact means.

3. Board connector assembly according to claim 1, wherein the shield and securing member is substantially [symbol] -shaped, surrounding said one or more contact means on the board on three sides.

4. Board connector assembly according to claim 3, wherein the shanks of the substantially [symbol] -shaped shield and securing member extend in a substantially parallel relationship relative to each other.

5. Board connector assembly according to claim 3, wherein the connector member comprises a housing which is configured to fit within the substantially [symbol] -shaped shield and securing member.

6. Board connector assembly according to claim 5, wherein the housing of the connector member is provided with an opening facing the free space between the shanks of the substantially [symbol] -shaped shield and securing member.

7. Board connector assembly according to claim 1, wherein the shield and securing member is made of metal for soldering onto the board.

8. Board connector assembly according to claim 1, wherein the coupling means on the shield and securing member comprise snap-in means which cooperate with coupling means in the form of mating snap-in means on the connector member.

9. Board connector assembly according to claim 8, wherein the snap-in means on the shield and securing member consist of snap-in holes and the snap-in means on the connector member consist of snap-in fingers, or vice versa.

10. Board connector assembly according to claim 5, wherein the coupling means on the substantially [symbol] -shaped shield and securing member are provided on the shanks thereof and the coupling means on the connector member on two opposite side surfaces of the housing thereof.

11. Board connector assembly according to claim 1, wherein the contact means on the connector member comprise spring means for connection to the contact means on the board.

12. Board connector assembly according to claim 1, wherein said board connector assembly further comprises a mechanical support which is configured to improve the load-carrying capacity of the connector member.

13. Shield and securing member for use in a board connector assembly according to claim 1.

14. Connector member for use in a board connector assembly according to claim 1.

15. Printed wiring board, comprising one or more board connector assemblies according to claim 1.
